(19) United States
(12) Patent Application Publication
(10) Pub. No.: US 2025/0296885 A1
(43) Pub. Date: Sep. 25, 2025

(54) DIELECTRIC COMPOSITION AND ELECTRONIC COMPONENT

(71) Applicant: TDK Corporation, Tokyo (JP)

(72) Inventors: Hiroki Akiba, Tokyo (JP); Ryota Nomura, Tokyo (JP)

(73) Assignee: TDK Corporation, Tokyo (JP)

(21) Appl. No.: 19/082,885

(22) Filed: Mar. 18, 2025

(30) Foreign Application Priority Data
Mar. 25, 2024 (JP) 2024-048547

(51) Int. Cl. C04B 35/495; H01G 4/12

(52) U.S. Cl. CPC C04B 35/495; H01G 4/1254; C04B 2235/3215; C04B 2235/3244; C04B 2235/3251; C04B 2235/85

(57) ABSTRACT

A dielectric composition includes a composite oxide having barium, zirconium, and tantalum as a main component. Content ratios of barium in terms of BaO is 48.5 mol % or more and 53.2 mol % or less, zirconium in terms of ZrO₂ is 3.5 mol % or more 25.2 mol % or less, and tantalum in terms of Ta₂O₅ is 26.2 mol % or more and 48.0 mol % or less in 100 mol % of the composite oxide. At least part of the crystalline particles includes a first area including tantalum and a second having a lower content ratio of tantalum than that in the first area. The second area partially or entirely surrounds the first. A content ratio of tantalum in the first area in terms of Ta₂O₅ represented by C1_{Ta} (mol %) and one in the second in terms of Ta₂O₅ represented by C2_{Ta} (mol %) satisfy a relation of C1_{Ta}—C2_{Ta}≥0.5 (mol %).

### TECHNICAL FIELD

The present disclosure relates to a dielectric composition and an electronic component including a dielectric layer made of the dielectric composition.

### BACKGROUND

Patent Document 1 discloses a technology relating to a dielectric composition including Sr and Ta as a main component.

Patent Document 2 discloses a technology relating to a dielectric ceramic composition which includes a first component containing one or more selected from the group consisting of oxides of Ca, oxides of Sr, and oxides of Ba, one or more selected from the group consisting of oxides of Ti and oxides of Zr, one or more selected from the group consisting of oxides of Nb and oxides of Ta as essential components; and a second component containing oxides of Mn.

### PRIOR ART DOCUMENT

### Patent Document

Patent Document 1: JP Patent Application Laid Open No.2022-111642

Patent Document 2: WO2018/074290

### SUMMARY

The object of the present disclosure is to provide a dielectric composition having excellent relative permittivity and loss tangent in a wide temperature range, and also exhibiting high AC withstand voltage. Also, the object of the present disclosure is to provide an electronic component having a dielectric layer made of the dielectric composition in a layer form.

### MEANS FOR SOLVING THE OBJECTS

In order to achieve the above-mentioned objects, the gist of the present disclosure is as described in below.

[1] A dielectric composition including:
a composite oxide including barium, zirconium, and tantalum as a main component;
wherein a content ratio of barium in terms of BaO is 48.5 mol % or more and 53.2mol % or less, a content ratio of zirconium in terms of ZrO₂ is 3.5 mol % or more 25.2 mol % or less, and a content ratio of tantalum in terms of Ta₂O₅ is 26.2 mol % or more and 48.0 mol % or less provided that a total content ratio of barium, zirconium, and tantalum in terms of BaO, ZrO₂, and Ta₂O₅ in the composite oxide is 100 mol %;
the dielectric composition includes crystalline particles made of the composite oxide as a main phase;
at least part of the crystalline particles are crystalline particles containing a first area including tantalum and a second area having a lower content ratio of tantalum than a content ratio of tantalum in the first area;
the second area partially or entirely surrounds the first area; and a content ratio of tantalum in the first area in terms of Ta₂O₅ represented by C1_{Ta} (mol %) and a content ratio of tantalum in the second area in terms of Ta₂O₅ represented by C2_{Ta} (mol %) satisfy a relation of C1_{Ta}—C2_{Ta}≥0.5 (mol %).

[2] The dielectric composition according to [1], wherein a number ratio “α” of crystalline particles satisfying C1_{Ta}—C2_{Ta}>0.5 (mol %) with respect to a total number of the crystalline particles made of the composite oxide is a ≥25%.

[3] An electronic component including a dielectric layer made of the dielectric composition according to [1] or [2] in a layer form, and an electrode.

### BRIEF DESCRIPTION OF DRAWINGS

FIG. 1 is a cross-sectional view of a multilayer capacitor according to an embodiment of the present disclosure.

FIG. 2 is a schematic view showing how a first area and a second area exist in a dielectric composition.

FIG. 3 is a schematic view explaining a method for calculating C1_{Ta} and C2_{Ta}.

FIG. 4 is an observation image of crystalline particles to which a line analysis of tantalum is performed in an example of the present disclosure.

FIG. 5 is a line analysis result of tantalum on a line shown in FIG. 4.

### DETAILED DESCRIPTION

The present disclosure is explained in details based on the specific embodiments in the order as shown below.

### 1. Electronic Component

1.1. Overall Configuration of Multilayer Capacitor
1.2. Dielectric Layer
1.3. Internal Electrode layer
1.4. External Electrode

### 2. Dielectric Composition

2.1. Composite Oxide
2.2 Main Phase

### 3. Method for Producing Multilayer Capacitor

### 4. Summary of the Embodiments

### 5. Modified Examples

### 1. Electronic Component

An electronic component according to the present embodiment includes a dielectric layer exhibiting a predetermined dielectric property and an electrode. As such electronic component, it may be configured in a way that one dielectric layer is placed between the electrodes; or the electronic component may be a multilayer electronic component in which a plurality of dielectric layers is stacked via the electrode layers. In the present embodiment, as an example, a multilayer capacitor is described.

### 1.1. Overall Configuration of Multilayer Capacitor

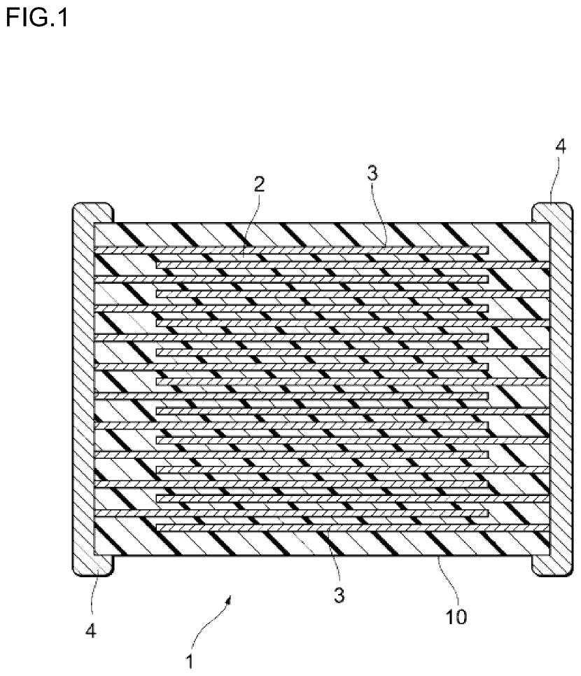

FIG. 1 shows a multilayer capacitor 1 as an example of the multilayer electronic component according to the present embodiment. The multilayer capacitor 1 includes an element main body 10 in which dielectric layers 2 and internal electrode layers 3 are stacked alternatingly on each other. At both ends of this element main body 10, a pair of external electrodes 4 is formed which respectively connects to the internal electrode layer 3 arranged in an alternating manner in the element main body 10. A shape of the element main body 10 is not particularly limited, and usually it is a rectangular parallelepiped shape.

Also, a dimension of the element main body 10 is not particularly limited, and it may be any dimension according to its use.

### 1.2. Dielectric Layer

The dielectric layer 2 is a layer form of the dielectric composition which is described in below. As a result, the multilayer capacitor having the dielectric layer 2 can exhibit high insulation breakdown voltage under high electric field intensity in a high temperature range.

A thickness per one layer of the dielectric layers 2 (interlayer thickness) is not particularly limited, and it can be set to any thickness according to a desired property, a purpose of use, and the like. Usually, the interlayer thickness is preferably 100 μm or less, and more preferably 30 μm or less. Also, the number of stacked layers of dielectric layers 2 can be set to any number. For example, in the case of the multilayer capacitor used for property evaluations and the like, the number of stacked layers may be several layers. In the case of the multilayer capacitor assembled in the actual product, the number of stacked layers may be 20 or more.

### 1.3. Internal Electrode Layer

In the present embodiment, as shown in FIG. 1, the internal electrode layers 3 are stacked so that each end of the internal electrode layers 3 is exposed on a pair of planes facing each other of the element main body 10. Specifically, in the pair of planes facing each other of the element main body 10, the internal electrode layer 3 are arranged so that every other ends of the internal electrode layers 3 are exposed on the same plane.

The internal electrode layer 3 is made of conductive materials. Examples of the conductive materials include conductive metals. In the present embodiment, examples of metals used as the conductive materials include, palladium (Pd), platinum (Pt), silver-palladium (Ag—Pd) alloy, nickel (Ni), nickel-based alloy, copper (Cu), and copper-based alloy. Note that, in nickel, nickel-based alloy, copper, and copper-based alloy, various trace components such as phosphorous (P) and/or sulfur(S) may be included by 0.1 mass % or less. Also, the internal electrode layer 3 may be formed using a commercially available electrode paste. A thickness of the internal electrode layer 3 may be determined according to its use and so on.

### 1.4. External Electrode

The external electrode is made of conductive materials. For example, as the external electrode 4, any known conductive materials may be used such as nickel (Ni), copper (Cu), tin (Sn), silver (Ag), palladium (Pd), platinum (Pt), gold (Au), alloy of these, and a conductive resin.

### 2. Dielectric Composition

In the present embodiment, the dielectric composition includes a composite oxide at least including barium (Ba), zirconium (Zr), and tantalum (Ta). The composite oxide is a main component which is included more than 50 mol % in 100 mol % of the dielectric composition. In the present embodiment, the composite oxide is preferably included by 75 mol % or more, and more preferably included by 90 mol % or more in 100 mol % of the dielectric composition.

The composite oxide preferably has a tungsten bronze-type crystal structure. In the case that the composite oxide has a tungsten bronze-type crystal structure, in the tungsten bronze-type crystal structure, an oxygen octahedron which is formed by six oxygens coordinating to a tetravalent element (zirconium) occupying the B site and an oxygen octahedron which is formed by six oxygens coordinating to a pentavalent element (tantalum) occupying the B site share their vertices, and a three-dimensional network is formed. Further, a divalent element (barium) occupying the A site is positioned in the space between these oxygen octahedrons.

### 2.1. Composite Oxide

In the present embodiment, a content ratio of barium in terms of BaO is 48.5 mol % or more and 53.2 mol % or less, a content ratio of zirconium in terms of ZrO₂ is 3.5 mol % or more and 25.2 mol % or less, and a content ratio of tantalum in terms of Ta₂O₅ is 26.2 mol % or more and 48.0 mol % or less with respect to 100 mol % of a total content ratio of barium, zirconium, and tantalum in terms of BaO, ZrO₂, and Ta₂O₅ in the composite oxide. When the content ratio of each element is within the above-mentioned range, the composite oxide tends to sinter easily. As a result, an electric energy loss (loss tangent) of the obtained dielectric composition is decreased, and AC withstand voltage improves. Also, a different phase is less likely to be formed.

The content ratio of barium in terms of BaO may be 50.2 mol % or more and 53.2 mol % or less. The content ratio of zirconium in terms of ZrO₂ may be 4.0 mol % or more and 20.0 mol % or less, or may be 4.0 mol % or more and 15.4 mol % or less. The content ratio of tantalum in terms of Ta₂O₅ may be 26.8 mol % or more and 45.8 mol % or less, or 31.4 mol % or more and 45.8 mol % or less.

### 2.2. Main Phase

The dielectric composition according to the present embodiment is a polycrystal, and many crystalline particles made of the above-mentioned composite oxide are connected via grain boundary phases. Therefore, the crystalline particles made of the above-mentioned composite oxide configures the main phase of the dielectric composition according to the present embodiment.

The crystalline particles configuring the main phase usually have approximately the same compositions in the entire areas of the particles. However, in the present embodiment, at least part of the crystalline particles configuring the main phase are particles containing a first area and a second area having different content ratios of tantalum within a particle.

That is, the crystalline particle as a whole have a predetermined composition, however, the content ratio of tantalum in the first area and the content ratio of tantalum in the second area are different. Specifically, the content ratio of tantalum in the first area is larger than the content ratio of tantalum in the second area. Also, the content ratio of tantalum in the first area is approximately constant, and the content ratio of tantalum in the second area is approximately constant. That is, in the crystalline particle, the change in the content ratios of tantalum near an interface between the first area and the second area is larger than the change in the content ratio of tantalum in the first area and the change in the content ratio of tantalum in the second area.

In the present embodiment, the change in the content ratios of tantalum near the interface between the first area and the second area is preferably large. Specifically, the content ratio of tantalum in the first area in terms of Ta₂O₅ represented by C1_{Ta} (mol %) and the content ratio of tantalum in the second area in terms of Ta₂O₅ represented by C2_{Ta} (mol %) satisfy a relation of C1_{Ta}—C2_{Ta}≥0.5 (mol %). As such, when the change in the content ratios of tantalum is large, the composition configuring the first area and the composition configuring the second area are clearly different, thus it is possible to benefit from both of the properties exhibited by the first area and the second area.

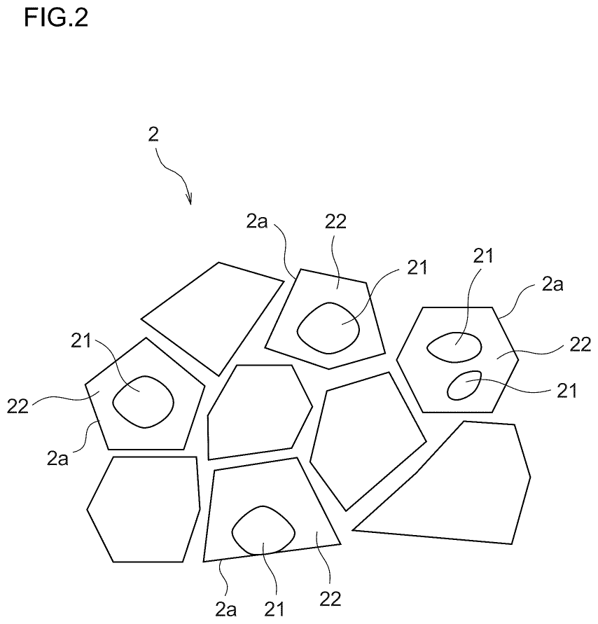

Further, in the present embodiment, as shown in FIG. 2, the crystalline particle 2a which contains the first area and the second area has a configuration that a first area 21 is partially or entirely surrounded by a second area 22. That is, the first area forms a so-called core part, and the second area forms a shell part. The second area 22 preferably surrounds 70% or more of a circumference length of the first area 21 and more preferably the second area 22 surrounds 100% of the circumference length of the first area 21; that is, the first area 21 is preferably entirely surrounded by the second area 22. A plurality of first areas may exists in a crystalline particle as long as it is surrounded by the second areas 22.

When the composite oxide satisfies the above-mentioned composition, the content ratios of tantalum satisfy the above-mentioned relation, and the first area and the second area satisfy the above-mentioned configurations, then it is possible to obtain the dielectric composition achieving good relative permittivity and loss tangent in a wide temperature range (for example, −55 to 150° C.). Also, it is possible to obtain the dielectric composition which the insulation breakdown of the crystalline particles during AC voltage application occurs at a high AC voltage (AC withstand voltage).

It is thought that such properties are caused since the second area having a higher resistance than the first area exists in the shell part where electric field concentrates while voltage is applied; thus, the AC withstand voltage of the crystalline particles as a whole increases. Also, the first area has a higher sintering property than the second area and facilitates the sintering property of the second area of low sinterbility; thus, the crystalline particles as a whole tends to sinter easily, and it is thought that pores which are formed due to insufficient sintering are reduced. As a result, it is thought that relative permittivity can be maintained high and electric energy loss (loss tangent) can be lowered.

C1_{Ta}—C2_{Ta} may be 2.0 mol % or larger, 5.2 mol % or larger, or 10.0 mol % or larger. The upper limit of C1_{Ta}—C2_{Ta} is, for example, 40.0 mol %.

In the present embodiment, when a number ratio of crystalline particles satisfying C1_{Ta}—C2_{Ta}≥0.5 (mol %) with respect to a total number of the crystalline particles made of the composite oxide is represented by “α”, then preferably “α” satisfies α≥25%. By having “α” within the above-mentioned range, AC withstand voltage tends to further improve.

Further, “α” may be 30.0% or larger.

Following shows an example of a method for identifying the crystalline particle containing the first area and the second area in the dielectric composition and a method for measuring C1_{Ta} in the first area and C2_{Ta} in the second area.

An arbitrary cross section of the dielectric composition is observed using a scanning transmission electron microscope (STEM) under a magnification capable of differentiating the crystalline particles configuring the main phase of the dielectric composition and the grain boundary phases between the crystalline particles, and also capable of identifying each crystalline particle. Thereby, the crystalline particles in the field of view are identified, and the number of crystalline particles is calculated. The magnification can be determined according to the crystalline particle size, and for example, it may be between about 10000× to 1000000×.

Next, in the same field of view, a mapping analysis of tantalum is carried out using an energy dispersive X-ray spectroscopy (EDS) attached to STEM. In a mapping image of tantalum obtained from the mapping analysis, an area configured of pixels with high luminance is the area where the content ratio of tantalum is high, and an area configured of pixels with low luminance is the area where the content ratio of tantalum is low. The area where the content ratio of tantalum is high and the area where the content ratio of tantalum is low may be determined based on the content ratio of tantalum calculated from the dielectric composition as a whole. Therefore, from the mapping image of tantalum, a crystalline particle in which the area with a low tantalum content ratio is partially or entirely surrounding the area with a high tantalum content ratio is defined as the crystalline particle containing the first area and the second area.

Next, a predetermined number of crystalline particles containing the first area and the second area which are identified as described in above is randomly selected. The selected number is for example 5 to 200 or so.

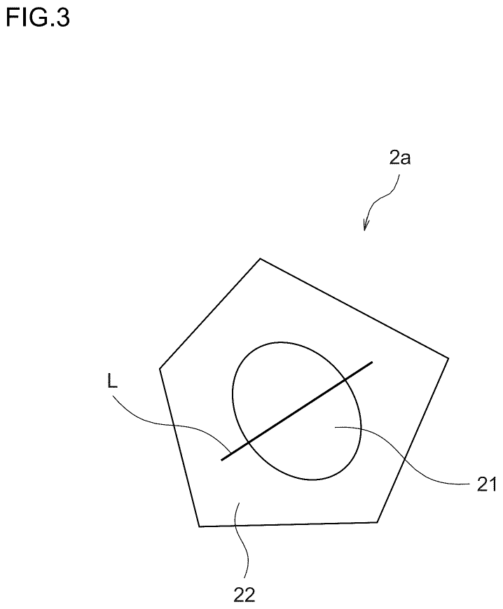

As shown in FIG. 3, to a randomly selected crystalline particle 2a containing the first area and the second area, a line L is drawn which crosses the first area 21 and has a start point and an end point in the second area 22. A point analysis is carried out using EDS in a sufficiently dense interval to the length of the drawn line L. In the present embodiment, for example, a point analysis is carried out to the drawn line L in 40 intervals or more.

From a result of the point analysis, a content ratio of Ta₂O₅ in each point is calculated. Then, the points where the point analysis have been carried out are aligned in an order of a point with a high Ta₂O₅ content ratio to a low Ta₂O₅ content ratio. Five points from the highest Ta₂O₅ content ratio are the points within the first area, and the average of the Ta₂O₅ content ratios of these five points is defined as the content ratio of Ta₂O₅ in the first area. Similarly, five points from the lowest Ta₂O₅ content ratio are points within the second area, and the average of the Ta₂O₅ content ratios of these five points is defined as the content ratio of Ta₂O₅ in the second area.

The above-mentioned point analysis is carried out to each of the randomly selected crystalline particles, and the average of the obtained content ratio of Ta₂O₅ in the first area is defined as C1_{Ta} and the average of the obtained content ratio of Ta₂O₅ in the second area is defined as C2_{Ta}. Using the obtained C1_{Ta} and C2_{Ta}, “C1_{Ta}—C2_{Ta}” is calculated.

A number ratio of the crystalline particles which “C1_{Ta}—C2_{Ta}” is 0.5 (mol %) or larger is calculated from the number of crystalline particles made of the composite oxide within the field of view and the number of crystalline particles satisfying “C1_{Ta}—C2_{Ta}” of 0.5 (mol %) or larger. Then, the obtained value is defined as “α”. “C1_{Ta}—C2_{Ta}” is calculated based on the cross-section image of the dielectric composition, thus even if a crystalline particle containing the first area and the second area exists in the cross-section image, this does not necessarily mean that both the first area and the second area appear in the cross-section image, and only the second area may be appearing in the cross-section image. Note that, the magnification of the field of view is about 10000× to 200000×, and the number of field of views is about 3 to 5.

The dielectric composition according to the present embodiment may include other components besides the main component. Such other components may be determined according to the desired properties. Examples of other components include oxides of Si, oxides of V, oxides of Mn, and oxides of Al. A content ratio of other components may be determined according to the desired properties.

### 3. Method for Producing Multilayer Capacitor

Next, an example of a method for producing the multilayer capacitor 1 shown in FIG. 1 is described in below.

The multilayer capacitor 1 according to the present embodiment can be produced using a known method which is the same for producing a conventional multilayer capacitor. For example, as the conventional method, a green chip is produced using a paste including raw materials of the dielectric composition, and then it is fired to produce the multilayer capacitor. Following describes the specific method for producing the multilayer capacitor.

First, starting raw materials of the dielectric composition are prepared. In the present embodiment, the starting raw materials are preferably powders. As the starting raw materials of the dielectric composition, a calcined powder of the main component configuring the main phase is prepared.

As the starting raw materials of the calcined powder of the main component, oxides of each metal included in the above-mentioned composite oxide which are the main component or various compounds which become the components configuring the composite oxide by firing can be used. Examples of the various compounds include carbonates, oxalates, nitrates, hydroxides, and organometallic compounds.

For example, a carbonate powder of barium, and oxide powders of zirconium and tantalum are prepared. Note that, an average particle size of each powder is, for example, within a range of 0.1 to 1.0 μm.

First, a raw material of barium and a raw material of tantalum are weighed and mixed so that a mol ratio of barium to tantalum is 1:2. A mixed powder is heat treated between a temperature range of 800 to 1100° C., for 0.5 to 3.0 hours in the air; thereby, the composite oxide of barium and tantalum is obtained. This composite oxide is, for example, represented by a chemical formula of BaTa₂O₆.

The obtained composite oxide of barium and tantalum is crushed, and the raw materials of barium, zirconium, and tantalum are added and mixed with the crushed powder so that the above-mentioned composition is achieved. The mixed powder is heat treated at conditions of 900 to 1400° C. for 0.5 to 10.0 hours under reducing atmosphere; thereby, the calcined powder of the main component is obtained. As the reducing atmosphere, preferably atmosphere is within a range of oxygen partial pressure PO₂ of 1.0×10⁻⁸ to 1.0×10⁻¹⁵ MPa.

By carrying out the heat treatment in two steps as mentioned in above to obtain the calcined powder of the main component, the crystalline particle containing the first area and the second area and having a tantalum concentration in each area satisfying the above-mentioned relation can be readily obtained.

Then, the obtained calcined powder of the main component is pulverized to obtain the raw material powder of the dielectric composition. An average particle size of the raw material powder of the dielectric composition is, for example, 0.5 μm to 2.0 μm.

In the case of including other components besides the main component into the dielectric composition, powders which become the raw materials of other components are also prepared. The powders which become other components may be added to the powders of the raw materials of the main component of before calcination and then the mixture may be calcined, or the raw materials of other component may be added to the calcined powder of the main component.

Next, a paste for producing the green chip is prepared. The obtained dielectric composition raw material powder, a binder, and a solvent are kneaded and formed into a paste to prepare the dielectric layer paste. For the binder and the solvent, known binders and solvents may be used. Also, the dielectric layer paste may include additives such as plasticizers if needed.

An internal electrode layer paste is obtained by kneading the above-mentioned conductive raw materials, a binder, and a solvent. For the binder and the solvent, known binders and solvents may be used. Also, the internal electrode layer paste may include additives such as inhibitors and plasticizers if needed.

An external electrode paste can be prepared as similar to the internal electrode layer paste.

A content of the binder and a content of the solvent in each of the above-mentioned pastes are not particularly limited, it may be any usual content. For example, the binder may be 1 mass % or more and 5 mass % or less, and the solvent may be 10 mass % or more and 50 mass % or less. Also, if needed, each paste may include additives selected from dispersants, plasticizers, dielectric materials, insulation materials, and so on. A total content of these is preferably 10 mass % or less.

For example, as a dispersant, a surfactant-type dispersant and a polymer-type dispersant can be used. As a plasticizer, for example, dioctyl phthalate and dibutyl phthalate can be used.

Using each of the obtained pastes, the green sheet and the internal electrode pattern are formed, and these are stacked to obtain the green chip.

Prior to firing, a binder removal treatment is performed to the green chip. As the binder removal condition, a temperature rising rate is preferably 5° C./hour to 300° C./hour, a holding temperature is preferably 180° C. to 500°° C., and a temperature holding time is preferably 0.5 hours to 24 hours. Also, the atmosphere is in the air or reducing atmosphere. Also, in the above-mentioned binder removal treatment, the atmosphere during the binder removal treatment may be humidified. A method for humidifying the atmosphere is not particularly limited. For example, a wetter may be used. In this case, a water temperature is 5° C. to 75° C. or so.

After the binder removal treatment, the green chip is fired to obtain an element main body. As the firing conditions, following conditions may be mentioned as examples. For example, a temperature rising rate may be 100 to 5000° C./hour, a holding temperature may be 1200 to 1450° C., a temperature holding time may be 0.5 to 2.0 hours, and a temperature decreasing rate may be 100 to 5000° C./hour. The atmosphere during firing may be in the air, or it may be under reducing atmosphere. In the case of reducing atmosphere, it may be atmosphere having oxygen partial pressure of 10⁻² o 10⁻⁷ Pa. As an atmospheric gas in the case of reducing atmosphere, a mixed gas of wet N₂ and H₂, wet N₂ gas, or so may be used. A method for humidifying the atmosphere is not particularly limited. For example, a wetter may be used. In this case, a water temperature is 5° C. to 75° C. or so.

After firing, if needed, an annealing treatment is carried out to the obtained element body. Annealing conditions may be known conditions. For example, a temperature rising rate may be 100 to 5000° C./hour, a holding temperature may be 850 to 1150° C., a temperature holding time may be 0.5 to 30 hours, and a temperature decreasing rate may be 100 to 5000° C./hour. The oxygen partial pressure during annealing treatment is preferably higher than the oxygen partial pressure during firing, and the holding temperature is preferably 1150° C. or lower. As an atmospheric gas during the annealing treatment, wet N₂ gas, a mixed gas of wet N₂ and H₂ or so may be used. A method for humidifying the atmosphere is not particularly limited. For example, a wetter may be used. In this case, a water temperature is 5° C. to 75° C. or so.

Also, the above-mentioned binder removal treatment, firing, and annealing treatment may be performed discontinuously or continuously.

The dielectric composition configuring the dielectric layer of the element main body obtained as such is the above-mentioned dielectric composition. By performing end surface polishing to this element and then applying and baking the external electrode paste, the external electrode 4 is formed. If necessary, a coating layer such as plating may be formed on the surface of the external electrode 4.

As such the multilayer capacitor according to the present embodiment is produced.

### 4. Summary of the Present Embodiment

In the present embodiment, regarding the dielectric composition including the composite oxide at least containing barium, zirconium, and tantalum, the composition of the composite oxide is controlled within the above-mentioned range. Further, at least part of the crystalline particles made of the composite oxide are the crystalline particles in which the content ratio of tantalum C1_{Ta} in the first area and the content ratio of tantalum C2_{Ta} satisfy the above-mentioned relation, and also the second area partially or entirely surrounds the first area.

Thereby, the second area having high insulation resistance is arranged to the periphery part (shell part) of the crystalline particle where electric field tends to easily concentrate during voltage application; thus, insulation breakdown of the crystalline particle is less likely to occur. Also, the composition configuring the first area has a higher sintering property and tends to be densified easily than the composition configuring the second area.

The sintering property of the second area contacting such area with high sintering property also improves. Also, because the second area is close to the grain boundary phases, pores formed by insufficient sintering tend to easily reach the grain boundary phases and are discharged easily. Thus, decrease of the properties (decrease of the relative permittivity, increase of loss tangent, etc.) caused by the insufficient sintering is less likely to occur.

As a result, it is possible to obtain the dielectric composition achieving excellent relative permittivity and loss tangent in the wide temperature range, and also the dielectric composition which the insulation breakdown of the crystalline particle during AC voltage application occurs at a high AC voltage (AC withstand voltage) can be obtained. That is, by arranging the two areas with different compositions in specific relative positions in the same particle, the two areas respectively suppress unfavorable properties of each other, and attains preferable properties in good balance. The larger the compositional differences of the two areas, the better such properties are.

When the number ratio (α) of the crystalline particles satisfying such configuration among the crystalline particles made of the above-mentioned composite oxide is within the above-mentioned range, AC withstand voltage is further improved.

### 5. Modified Example

In the above-mentioned embodiment, the case which the multilayer capacitor is the electronic component according to the present embodiment is described, however, the electronic component according to the present embodiment is not limited to the multilayer capacitor, and it may be any electronic component including the above-mentioned dielectric composition.

Hereinabove, the embodiment of the present disclosure is described, however, the present disclosure is not limited to the above-mentioned embodiments, and various modifications are possible within the scope of the present disclosure.

### EXAMPLES

In below, the present disclosure is described in further detail using examples and comparative examples. Note that, the present disclosure is not limited to the below-described examples.

### Experiment 1

First, as starting raw materials of the main component, each powder of BaCO₃, ZrO₂, and Ta₂O₅ having an average particle size of 1.0 μm or less were prepared. BaCO₃ and TA₂O₅ were weighed and mixed so that a mol ratio of barium to tantalum was 1:2. The mixed powder was heat treated at 900° C. for 3 hours in the air, and a composite oxide which is represented by a chemical formula of BaTa₂O₆ was obtained.

The obtained composite oxide was crushed. The crushed powder was added with BaCO₃, ZrO₂, and Ta₂O₅ and mixed so as to obtain the composition shown in Table 1. The mixed powder was heat treated at 1200° C. for 4 hours, and under oxygen partial pressure PO₂ of 1.0×10⁻¹⁰ MPa; thereby, a calcined powder of the main component was obtained.

The calcined powder of the main component obtained using the above-mentioned method was pulverized, and the raw material powder of the dielectric composition was obtained. Next, a solvent was prepared by adding 700 g of a mixture of toluene+ethanol solution (toluene:ethanol=50:50 (weight ratio)), a plasticizer (dioctyl phthalate (DOP) (manufactured by J-Plus)), and a dispersant (Mariarim AKM-0531 (manufactured by Nisshin Oil)) in a ratio of 90:6:4 (weight ratio), to 1000 g of the raw material powder of the dielectric composition; thereby, a mixture was obtained. Next, the obtained mixture was dispersed for two hours using a basket mill. Note that, for all of the samples, a viscosity of the dielectric layer paste was adjusted to be 200 cps. Specifically, the viscosity was adjusted by adding a small amount of the toluene+ethanol solution.

As a raw material of an internal electrode layer, a Ni powder having an average particle size of 0.2 μm, an oxide powder of Al having an average particle size of 0.1 μm or less, and an oxide powder of Si an average particle size of 0.1 μm or less were prepared. These powders were weighed and mixed so that a total of Al and Si was 5 mass % with respect to Ni. Then, a heat treatment was performed in a mixed gas of wet N₂ and H₂ at 1200° C. or higher. The heat-treated powder was pulverized using a ball mill or so, and a raw material powder of the internal electrode layer having an average particle size of 0.20 μm was obtained.

100 mass % of the raw material powder of the prepared internal electrode layer, 30 mass % of the organic vehicle (8 mass % of an ethylcellulose resin dissolved in 92 mass % of butyl carbitol), and 8 mass % of butyl carbitol were kneaded using a triple roll to form a paste; thereby, the internal electrode layer paste was obtained.

Then, the obtained dielectric layer paste was applied on a PET film to form a green sheet. Here, it was adjusted so that the dried green sheet had a thickness of 4.2 μm. Next, using the internal electrode layer paste, the internal electrode layer of a predetermined pattern was printed on the green sheet. Then, the green sheet was released from the PET film; thereby, the green sheet having the internal electrode layer printed in a predetermined pattern was produced. Next, a plurality of green sheets having the internal electrode layer printed in a predetermined pattern was stacked, and pressure adhesion was carried out to form a green multilayer body. Further, the green multilayer body was cut into a predetermined shape, thereby green chips were obtained.

Next, regarding the obtained green chips, a binder removal treatment, firing, and an annealing treatment were carried out to obtain a multilayer ceramic fired body. Conditions of the binder removal treatment, firing, and annealing treatment were as described in below. Also, regarding the binder removal treatment, firing, and annealing treatment, a wetter was used for humidifying the atmosphere gas.

### Binder Removal Treatment

Temperature rising rate: 100° C./hour
Holding temperature: 400° C.
Temperature holding time: 8.0 hours
Atmosphere gas: Mixed gas of wet N₂ and H₂

### Firing

Temperature rising rate: 500° C./hour
Firing temperature: 1200° C. to 1450° C.
Temperature holding time: 2.0 hours
Temperature decreasing rate: 100° C./hour
Atmosphere gas: Mixed gas of wet N₂ and H₂
Oxygen partial pressure: 10⁻² to 10⁻⁷ Pa

### Annealing Treatment

Temperature rising rate: 200° C./hour
Holding temperature: 800° C. to 1000° C.
Temperature holding time: 2.0 hours
Temperature decreasing rate: 200° C./hour

### Atmosphere gas: Wet N₂ gas

Oxygen partial pressure: 10⁻¹ Pa

A compositional analysis of the dielectric layer (dielectric composition) of obtained each fired body was carried out using an ICP emission spectroscopy. According to the result of the compositional analysis, it was confirmed that the analyzed composition had the same composition as shown in Table 1. Also, an X ray diffraction measurement was carried out to the dielectric composition, and according to the result, it was confirmed from the obtained X-ray diffraction pattern that the dielectric composition had a tungsten bronze-type crystal structure.

End surfaces of the obtained fired body was polished using sandblast, then an In—Ga eutectic alloy was coated as an external electrode; thereby, a multilayer capacitor sample having the same shape as the multilayer capacitor shown in FIG. 1 was obtained. A size of the obtained multilayer capacitor sample was 3.2 mm×1.6 mm×1.2 mm; and a thickness of the dielectric layer was 3 μm and a thickness of the internal electrode layer was 1.5 μm. The number of dielectric layers placed between the internal electrode layers were 10 layers.

A cross-section of the dielectric layer (dielectric composition) along the layering direction of the obtained each multilayer ceramic capacitor sample was polished, then the polished cross-section was observed using a scanning transmission electron microscope (STEM) at 100000× magnification to identify the crystalline particles configuring the main phase. Next, a mapping analysis of tantalum was carried out using an energy dispersive X-ray spectroscopy (EDS) attached to STEM. Based on the result of the mapping analysis, a crystalline particle in which an area with a low tantalum content ratio partially or entire surrounding an area with a high tantalum concentration ratio was considered as the crystalline particle containing the first area and the second area.

Next, ten crystalline particles containing the first area and the second area were selected, then on each of the crystalline particles, a straight line which crosses the first area and having a start point and an end point in the second area was set. Then, a point analysis was carried out using EDS by dividing the straight line in equal 41 intervals. For each particle, an average value from the top five of the high Ta₂O₅ content ratios was considered as a Ta₂O₅ content ratio of the first area and an average value from the bottom five of the low Ta₂O₅ content ratios was considered as a Ta₂O₅ content ratio of the second area. From the point analysis results carried out to the ten particles, an average TA₂O₅ content ratio of the first area was calculated and defined as C1_{Ta}. Similarly, an average TA₂O₅ content ratio of the second area was calculated and defined as C2_{Ta}. Using the obtained C1_{Ta} and C2_{Ta}, “C1_{Ta}—C2_{Ta}” was calculated. Results are shown in Table 1.

Next, using the number of all crystalline particles existing in the field of view and the number of crystalline particles with C1_{Ta}—C2_{Ta} of 0.5 (mol %) or larger, a number ratio (α) of the crystalline particles satisfying C1_{Ta}—C2_{Ta} of 0.5 (mol %) or larger was calculated.

The results are shown in Table 1.

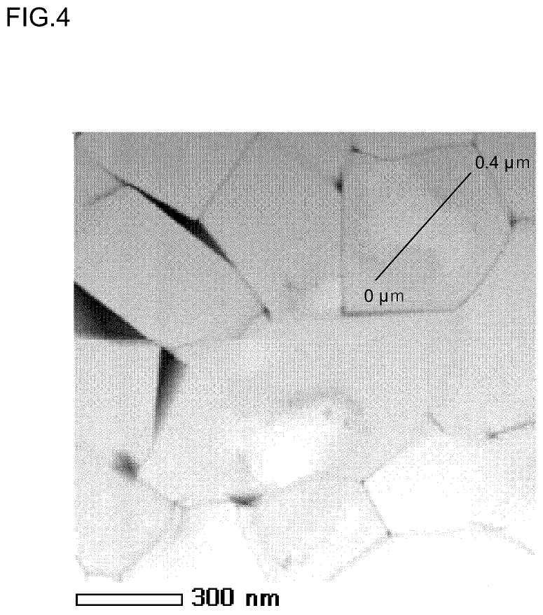

FIG. 4 is a STEM observation image of one of the crystalline particles to which a line analysis of tantalum was carried out in Sample No.17. It was confirmed that the crystalline particle shown in FIG. 4 had two areas with contrast differences, and one of the areas surrounded the other area.

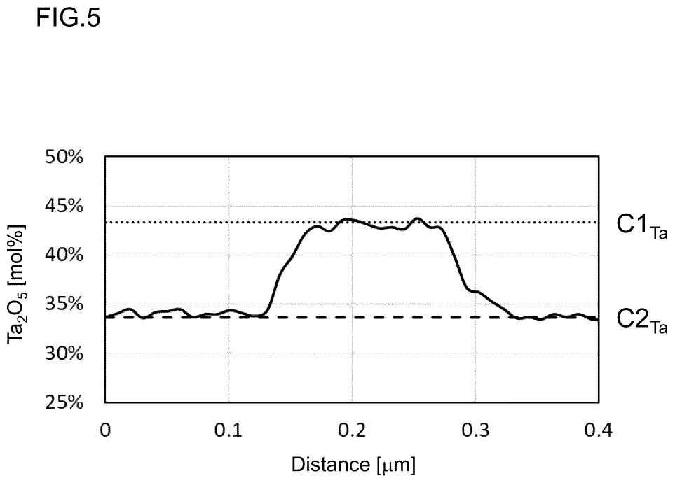

FIG. 5 shows a point analysis result of tantalum on the line shown in FIG. 4. The surrounded area had a high tantalum content ratio and the surrounding area had a low tantalum content ratio. That is, in the crystalline particle shown in FIG. 4, it was confirmed that the first area was surrounded by the second area.

TABLE 1

| | Main phase | | | | | | | | Property | | |
|---|---|---|---|---|---|---|---|---|---|---|---|
| | | | | Crystalline particle | | | | | Relative | | AC |
| | Composite oxide | | | Presence of | | | C1_{Ta}- | | permit- | loss | withstand |
| Sample | BaO | ZrO₂ | Ta₂O₅ | first area and | C1_{Ta} | C2_{Ta} | C2_{Ta} | | tivity | tangent | voltage |
| No. | (mol %) | (mol %) | (mol %) | second area | (mol %) | (mol %) | (mol %) | α | ε | tan δ | (V/μm) |
| 1 | 50.0 | 2.0 | 48.0 | Not observed | — | — | — | — | 96 | 0.5% | 80 |
| 2 | 48.0 | 4.0 | 48.0 | Not observed | — | — | — | — | 94 | 12.6% | 81 |
| 3 | 48.5 | 4.0 | 47.5 | Not observed | — | — | — | — | 96 | 0.6% | 82 |
| 4 | 50.0 | 4.0 | 46.0 | Observed | 46.5% | 45.9% | 0.6% | 15% | 95 | 0.6% | 92 |
| 5 | 52.0 | 4.0 | 44.0 | Observed | 45.8% | 43.6% | 2.1% | 25% | 104 | 0.3% | 101 |
| 6 | 53.2 | 4.0 | 42.8 | Observed | 43.9% | 42.6% | 1.3% | 18% | 96 | 0.2% | 96 |
| 7 | 53.5 | 4.0 | 42.5 | Observed | 44.5% | 42.1% | 2.4% | 15% | 96 | 0.2% | 83 |
| 8 | 48.0 | 8.0 | 44.0 | Not observed | — | — | — | — | 94 | 13.0% | 77 |
| 9 | 48.5 | 8.0 | 43.5 | Observed | 45.5% | 43.1% | 2.3% | 25% | 105 | 0.5% | 101 |
| 10 | 50.0 | 8.0 | 42.0 | Observed | 45.2% | 40.8% | 4.4% | 25% | 104 | 0.5% | 103 |
| 11 | 52.0 | 8.0 | 40.0 | Observed | 45.2% | 38.6% | 6.6% | 28% | 107 | 0.2% | 105 |
| 12 | 53.2 | 8.0 | 38.8 | Observed | 43.1% | 37.9% | 5.1% | 25% | 107 | 0.1% | 103 |
| 13 | 53.5 | 8.0 | 38.5 | Observed | 46.2% | 36.2% | 10.0% | 18% | 102 | 0.2% | 86 |
| 14 | 48.0 | 10.0 | 42.0 | Observed | 45.5% | 40.9% | 4.6% | 20% | 95 | 11.4% | 75 |
| 15 | 48.5 | 10.0 | 41.5 | Observed | 45.9% | 40.6% | 5.2% | 25% | 108 | 0.6% | 105 |
| 16 | 50.0 | 10.0 | 40.0 | Observed | 43.7% | 39.2% | 4.5% | 25% | 110 | 0.5% | 103 |
| 17 | 52.0 | 10.0 | 38.0 | Observed | 43.2% | 36.3% | 6.8% | 28% | 108 | 0.2% | 106 |
| 18 | 53.2 | 10.0 | 36.8 | Observed | 42.9% | 35.3% | 7.6% | 28% | 107 | 0.2% | 108 |
| 19 | 53.5 | 10.0 | 36.5 | Observed | 46.1% | 34.6% | 11.5% | 23% | 103 | 0.4% | 85 |
| 20 | 48.0 | 20.0 | 32.0 | Observed | 45.0% | 28.7% | 16.4% | 30% | 96 | 13.2% | 78 |
| 21 | 48.5 | 20.0 | 31.5 | Observed | 42.8% | 28.3% | 14.4% | 33% | 118 | 0.6% | 115 |
| 22 | 50.0 | 20.0 | 30.0 | Observed | 44.2% | 27.2% | 17.0% | 38% | 114 | 0.6% | 116 |
| 23 | 52.0 | 20.0 | 28.0 | Observed | 42.8% | 23.5% | 19.2% | 35% | 116 | 0.3% | 117 |
| 24 | 53.2 | 20.0 | 26.8 | Observed | 45.5% | 22.2% | 23.3% | 33% | 108 | 0.4% | 115 |
| 25 | 53.5 | 20.0 | 26.5 | Observed | 43.3% | 21.9% | 21.3% | 28% | 102 | 0.3% | 87 |
| 26 | 48.0 | 25.2 | 26.8 | Observed | 43.6% | 24.2% | 19.4% | 30% | 92 | 14.2% | 76 |
| 27 | 48.5 | 25.2 | 26.3 | Observed | 44.0% | 21.8% | 22,2% | 38% | 106 | 0.5% | 113 |
| 28 | 50.0 | 25.2 | 24.8 | Observed | 44.8% | 20.0% | 24.8% | 33% | 108 | 0.6% | 87 |
| 29 | 52.0 | 25.2 | 22.8 | Observed | 42.8% | 16.8% | 26.0% | 35% | 107 | 0.4% | 89 |
| 30 | 53.2 | 25.2 | 21.6 | Observed | 44.7% | 15.0% | 29.7% | 30% | 107 | 0.4% | 85 |
| 31 | 53.5 | 25.2 | 21.3 | Observed | 43.8% | 17.4% | 26.4% | 33% | 104 | 0.4% | 81 |
| 32 | 50.0 | 28.0 | 22.0 | Observed | 43.5% | 17.9% | 25.6% | 48% | 88 | 22.3% | 70 |

For the obtained multilayer capacitor sample, relative permittivity and loss tangent in the temperature range of −55 to 150° C., and withstand voltage while applying AC voltage (AC withstand voltage) were measured using methods as described in below.

### Relative Permittivity and Loss Tangent

A digital LCR meter (4284A made by YHP) was used to the multilayer ceramic capacitor sample in the temperature range of −55 to 150° C. at a frequency of 1 kHz and an input signal level (measuring voltage) of 1 Vrms; thereby, capacitance and loss tangent were measured. The relative permittivity (no unit) was calculated based on the thickness of the dielectric layer, an effective electrode area, and the capacitance obtained from the measurement. Within the temperature range of −55 to 150° C., the smallest relative permittivity among the calculated relative permittivities was considered as a relative permittivity of the present example. The higher the relative permittivity, the more preferable it is. In the present example, the sample having the relative permittivity of 90 or larger was considered good. Also, within the temperature range of −55 to 150° C., the largest loss tangent among the measured loss tangents was considered as the loss tangent of the present example. The lower the loss tangent, the more preferable it is. In the present example, the sample having the loss tangent of less than 1% was considered good. The results are shown in Table 1.

### AC Withstand Voltage

AC voltage was applied to the multilayer ceramic capacitor sample at 25° C., and the voltage at which a leakage current exceeded 10 mA was measured. Then, the voltage was divided by the thickness of the dielectric layer; thereby, withstand voltage per unit thickness was considered as AC withstand voltage. The higher the AC withstand voltage, the more preferable it is. In the present example, the sample having AC withstand voltage of 90 V/μm or larger was considered preferable. Further, the sample having the AC withstand voltage of 100 V/μm or larger was more preferable. The results are show in Table 1.

According to Table 1, it was confirmed that the multilayer capacitor can achieve good relative permittivity and loss tangent in a wide temperature range, and further achieve high AC withstand voltage when the multilayer capacitor sample included the dielectric composition including the crystalline particles in which the composition of the composite oxide including barium, zirconium, and tantalum were within the above-mentioned range, contained the first area and the second area in the main phase made of the composite oxide, and the content ratios of tantalum in the first area and the second area satisfied the above-mentioned relation.

### REFERENCE SIGNS LISTS

1. . . Multilayer capacitor
10. . . Element main body
2. . . Dielectric composition
2a. . . Crystalline particle
21. . . First area
22. . . Second area
3. . . Internal electrode layer
4. . . External electrode

What is claimed is:

1. A dielectric composition comprising:
a composite oxide comprising barium, zirconium, and tantalum as a main component;
wherein a content ratio of barium in terms of BaO is 48.5 mol % or more and 53.2 mol % or less, a content ratio of zirconium in terms of ZrO₂ is 3.5 mol % or more 25.2 mol % or less, and a content ratio of tantalum in terms of Ta₂O₅ is 26.2 mol % or more and 48.0 mol % or less provided that a total content ratio of barium, zirconium, and tantalum in terms of BaO, ZrO₂, and Ta₂O₅ in the composite oxide is 100 mol %;
the dielectric composition comprises crystalline particles made of the composite oxide as a main phase;
at least part of the crystalline particles are crystalline particles containing a first area including tantalum and a second area having a lower content ratio of tantalum than a content ratio of tantalum in the first area;
the second area partially or entirely surrounds the first area; and
a content ratio of tantalum in the first area in terms of Ta₂O₅ represented by C1_{Ta} (mol %) and a content ratio of tantalum in the second area in terms of Ta₂O₅ represented by C2_{Ta} (mol %) satisfy a relation of C1_{Ta}—C2_{Ta}≥0.5 (mol %).

2. The dielectric composition according to claim 1, wherein a number ratio “α” of crystalline particles satisfying C1_{Ta}—C2_{Ta}≥0.5 (mol %) with respect to a total number of the crystalline particles made of the composite oxide is α≥25%.

3. An electronic component comprising a dielectric layer made of the dielectric composition according to claim 1 in a layer form, and an electrode.
